(19) United States
(12) Patent Application Publication
(10) Pub. No.: US 2001/0049658 A1
(43) Pub. Date: Dec. 6, 2001

(54) Method and system for providing an online collections services marketplace

(76) Inventor: David Allen Hays, Tucson, AZ (US)

Correspondence Address: Yisun Song, Esq., Hunton & Williams, Suite 1200, 1900 K Street, N.W., Washington, DC, 20006, US

(21) Appl. No.: 09/866,730

(22) Filed: May 30, 2001

Related U.S. Application Data
(60) Provisional application No. 60/207,951, filed on May 31, 2000.

(51) Int. Cl. G06F 17/60

(52) U.S. Cl. 705/40; 705/1

(57) ABSTRACT

An on-line marketplace for entities providing collection services and those requesting collection services is presented. The web-site of the present invention may assist Clients in identifying the most effective set of Providers in connection with the characteristics of their receivables. The present invention may also provide a method for rating the effectiveness of the collection companies as well as a method for rating the quality of the receivables where Clients may evaluate and select one or more appropriate Providers. A database of collected receivables, data mining techniques, or neural networks may be used to examine a set of receivables and determine a set of collection services for an optimal return. A client may select one or more providers based on a self-selection process, an optimization process, an auction process or other selection method.

### FIELD OF INVENTION

The present invention relates to a method and system for providing an online collections services marketplace and for enabling users to view client and service provider information and delinquent accounts receivable information.

### BACKGROUND OF THE INVENTION

Due to the vast amount of consumer and other types of debts, many businesses or individuals occasionally or regularly consult third-party collection services, performed by third-party agencies, collection attorneys, or other entities.

Traditionally, marketing for collection agencies involves banks of telephone solicitors calling hundreds of businesses each and every day, on the offhand chance they might have a current need for collection services. Oftentimes, attorneys or other entities passively wait for potential clients to come in the door. While agencies can directly solicit potential clients via phone or other methods for their collection business, attorneys cannot due to guidelines established by state Bar Associations. Therefore, collection attorneys are severely limited in their ability to market their services to the public. As a result, they lose potential clients to other collection entities. This reduces the amount of competition and bargaining, which results in higher charges for collection services.

Currently, companies or other entities find it difficult, if not impossible, to compare service providers. The lack of knowledge regarding past successes or failures restricts the ability to make an educated choice of provider. This may lead to unclaimed accounts and other financial losses.

These and other drawbacks exist with current systems.

### SUMMARY OF THE INVENTION

The present invention provides an on-line marketplace for entities providing collection services and those requesting collection services through a web-site. The web-site may assist clients in identifying the most effective set of providers in connection with the characteristics of their receivables and other factors. A Client may include an individual, group of individuals, company, commercial enterprise, attorney, law firm and other entity requesting collection services from the present invention. A Provider may include an individual, group of individuals, company, commercial enterprise and other entity (e.g., a collection entity, a collection company, etc.) providing collection services through the present invention. The present invention may also provide a method for rating the effectiveness of the collection entities where Clients may evaluate and select one or more appropriate Providers. The present invention further enables a Client to select one or more Providers via a selection process, which may include a self selection process, optimization process, auction process or other selection process. For example, a Client may search for one or more Providers based on Client defined characteristics. In another example, a database of collected receivables, data mining techniques, or neural networks may be used to examine a set of receivables and determine a set of collection services for an optimal return. In another example, an auction function associated with the present invention may also be available where Clients may specify parameters and auction a defined set of receivables. In this example, the Client may specify parameters thereby limiting the bidding process to select Providers. The bidding process may provide the Client with each Provider's bid, an efficiency rating associated with each Provider, and other information.

Other objects and advantages of the present invention will be apparent to one of ordinary skill in the art upon reviewing the specification herein.

### BRIEF DESCRIPTION OF THE DRAWINGS

FIG. 1 is a diagram of an overview of a collection services system according to an embodiment of the present invention.

FIG. 2 is a flowchart of a method for providing collections services according to an embodiment of the present invention.

FIG. 3 is a flowchart of a process for sign up and initial business rating of a collection entity according to an embodiment of the present invention.

FIG. 4 is a flowchart of a process for sign up and initial business rating of a Client according to an embodiment of the present invention.

FIG. 5 is a flowchart of a process for rating a Client's paper or other receivable according to an embodiment of the present invention.

FIG. 6 is a flowchart of a process for an auction of paper according to an embodiment of the present invention.

FIG. 7 is a flowchart of a process for optimization according to an embodiment of the present invention.

FIG. 8 is a flowchart of a process for manual selection of collection entities by a Client according to an embodiment of the present invention.

FIG. 9 is a flowchart of a process for dynamically rating a Client according to an embodiment of the present invention.

FIG. 10 is a flowchart of a process for dynamically rating collection entities according to an embodiment of the present invention.

### DETAILED DESCRIPTION OF THE PREFERRED EMBODIMENTS

The present invention provides a method and system for marketing, comparing, and purchasing collection services from collection agencies, attorneys and other entities. Other operations and features may also be provided. In addition, the present invention may provide potential Clients the ability to investigate the qualifications of collection service Providers and the opportunity to choose from several selection alternatives and qualified service Providers on the basis of contingent rate or other limitations.

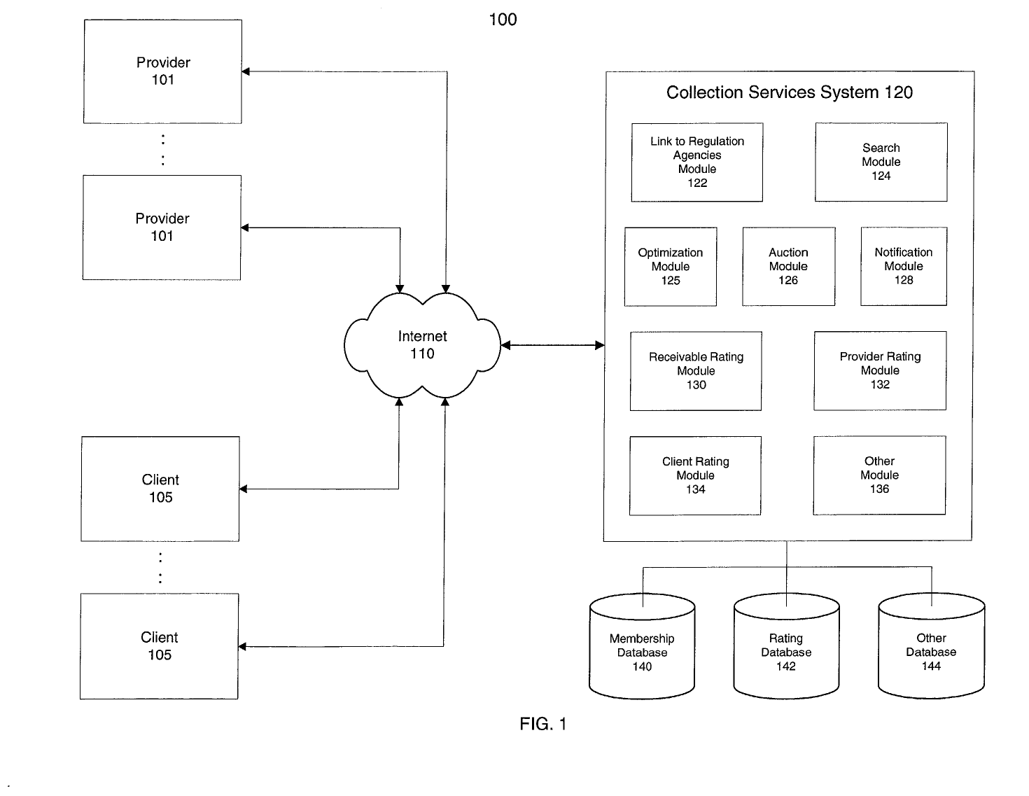

FIG. 1 illustrates an overview of an example of a collection services system according to an embodiment of the present invention. One or more Providers 101 and one or more potential or current Clients 105 may access Collection Services System 120 through the Internet 110. Collection Services System 120 may include various modules, such as Link to Regulation Agencies 122, Search Module 124, Optimization Module 125, Auction Module 126, Notification Module 128, Receivable Rating Module 130, Provider Rating Module 132, Client Rating Module 134 and Other Module 136. Membership Database 140 may include information related to third-party collection agencies, collection attorneys, companies and other entities or participants. Rating Database 142 may include rating information related to collection entities, Clients, papers (e.g., receivables) and other information. Other information may also be stored in Other Database 144.

Each participant (e.g., Providers, Clients, etc.) may subscribe to a membership with the system where the participant supplies information to the system. This information may then be stored in Membership Database 140 which may be accumulated and compiled. Other methods for obtaining participant information may also be used. Provider information may include information related to type of Provider, areas of specialization (e.g., commercial, consumer, or both), size of Provider company, professional association memberships, references, industries served, range of contingent rates, geographical areas served, services provided, and other information a Client may find relevant in making a decision as to which Provider to use. Other information may also be stored in Membership Database 140. Rating Database 142 may store collection agency/lawyer ratings, Client ratings, paper ratings, and other ratings information.

Link to Regulation Agencies Module 122 may provide various state regulatory agencies which may apprise the system of any actions or complaints pending against Providers in such states. Through Link Module 122, this information may be made available to Clients. Each Provider may be allowed a uniform information page within the present invention at which promotional material and other information may be available.

According to an embodiment of the present invention, a Client may select one or more Providers through Search Module 124, Optimization Module 125, Auction Module 126 and/or other selection methods.

Search Module 124 may enable potential Clients to use Membership Database 140 and a Search tool to investigate Providers using a variety of search parameters or other user defined criteria. In addition, contact information may be supplied to potential Clients. This aspect of the invention enables potential Clients to correspond with Providers. Also, once potential Clients investigate the available Providers, if they decide they wish to use an attorney, the attorney contacted is entitled to proactively follow up such initial Client-initiated contact. This opens up an entire area of marketing to attorneys, and places them on a competitive footing similar to that of third-party agencies.

Optimization Module 125 may enable potential Clients to be presented with an optimal Provider or a list of optimal Providers based on various factors. Clients may specify preference information, which may include various Provider characteristics. In addition, type of return and other information may be specified as well. Type of return may include maximum return, time frame (e.g., shortest time frame, specified deadline, etc.) and other user defined criteria, for example. An optimal collection entity or combination of collection entities may be presented based on defined criteria. The potential client may then accept or select a desired Provider. Auction module 126 may enable potential Clients to specify one or more Providers they wish to have notified of the opportunity to bid on a defined set of accounts. Selected Providers may be notified of an opportunity to bid on the accounts, on the type and location of the accounts to be bid upon, and other terms of the bidding. Notification may be made by email, an instant message mechanism, cell phone, phone, fax or other mode of communication. Limits may be placed on the number and/or qualification of Providers that may bid on any given prospective placement, if administratively necessary. Other limitations may be defined. The Providers may be able to view the current bids of some or all Providers without knowing who the other selected Providers are, thereby creating a true competitive situation. Limitations may be placed on the display of bids. For example, Providers may view the current best bids. The winning bidder may then be notified and the accounts placed with that Provider.

Notification Module 128 may provide an electronic link between the system and a Provider, which notifies such Provider of a selection by a potential Client. This facilitates the selection process and allows faster responses by the selected Providers. This feature may be provided as an option to Providers. According to another embodiment, the Provider may be contractually obligated to notify the system of the accounts that are collected, so that the system may invoice them for the agreed-upon transaction fee. Clients may also notify the system of accounts collected, which may act as a “check-and-balance” system.

Receivable Rating Module 130 may provide a mechanism for rating delinquent receivables, accounts or other papers. This feature may enable Providers to make intelligent and educated decisions regarding the receivables being presented. This feature further enables Providers to quote competitive rates. The rating system may include information regarding whether the debtors have a good working phone and current address, whether the account is commercial or consumer in nature, whether there is any known barriers to collecting the receivable, such as bankruptcy filing or other impediment, whether there is a personal guarantee on an obligation that is otherwise a corporation obligation, and other considerations. According to an embodiment of the invention, the Client may be made responsible for the accuracy of the information provided, with a provision that the accounts placed, if such information is not accurate, may be returned to the Client for further review. The system may also be involved in ensuring the accuracy of the information provided.

Provider Rating Module 132 may enable a potential Client to view historical and current characteristics of Providers. This information may assist potential Clients in determining how successful the Provider has been in the past in actually collecting accounts placed with it. This information may include number of dollars collected and number of dollars placed where the information may be broken down by type of receivables or papers, age of receivables or paper, geographical location of the debtor and other factors. This feature of the present invention enables potential Clients to proactively evaluate and choose one or more appropriate Providers. In addition, knowing that the Provider's current efforts may be a factor in the Provider's future rating may provide an incentive for effective efforts on the part of the Provider.

According to another embodiment, a rating system may analyze the prospective collection portfolio and optimize the results that might be obtained by the Client, utilizing some or all of the historical information, as well as contingent rates historically charged by the various Providers. Other limitations and data may also be utilized. The Client may then be provided with a listing of the Providers to select for each debt to be placed so as to maximize the return to the Client.

The present invention offers several advantages to potential Clients, Providers, and the marketplace. For instance, by making past results discoverable, the system may foster a greater possible effort on the part of Providers to successfully collect the accounts placed for collection through the present invention. Also, the system may reward those Providers that provide effective, professional service, leading to a more responsive, effective, efficient, orderly and professional industry in general. By making results and other information regarding the successes and failures of Providers discoverable through the present invention, credibility may be imparted to the collection process and its marketplace. By allowing for weight (or scores) to be given to companies which collect more total dollars than others, Providers may be encouraged to report to the present invention all amounts collected, in order to boost their Provider rating and thereby secure an increased number of accounts referred to it. By making such information available to Providers themselves, the present invention may assist such Providers in maintaining profitability while offering competitive contingent rates.

According to another embodiment, Clients may be prompted at regular intervals to evaluate the service and results provided by the service Providers with whom they are doing business. The results of these surveys may be discoverable through the present invention. This feedback feature may alert management of the Providers when a potential problem exists in the service being provided, thus allowing that management to make changes to assist in achieving and maintaining higher ratings. Client Rating Module 134 may enable Providers to acquire information on Clients for whom they will prospectively be working and whose delinquent account they may be servicing. A Client rating system of the present invention may provide information to Providers regarding all aspects of the Client, such as the size of the Client's business, how many open accounts the Client has, the average age of their collections placement, the percentage of the Client's placements that have been historically collected, and other information. Providers may be periodically prompted to provide feedback on the Clients for whom they have been working, including availability and reliability of the Client's information on the delinquent accounts placed, and other information. This may assist the Client in rectifying potential internal problems that are, or may be, negatively impacting the results being obtained from the collections efforts.

Other modules, as illustrated by module 136, may also be implemented in accordance with the scope of the present invention.

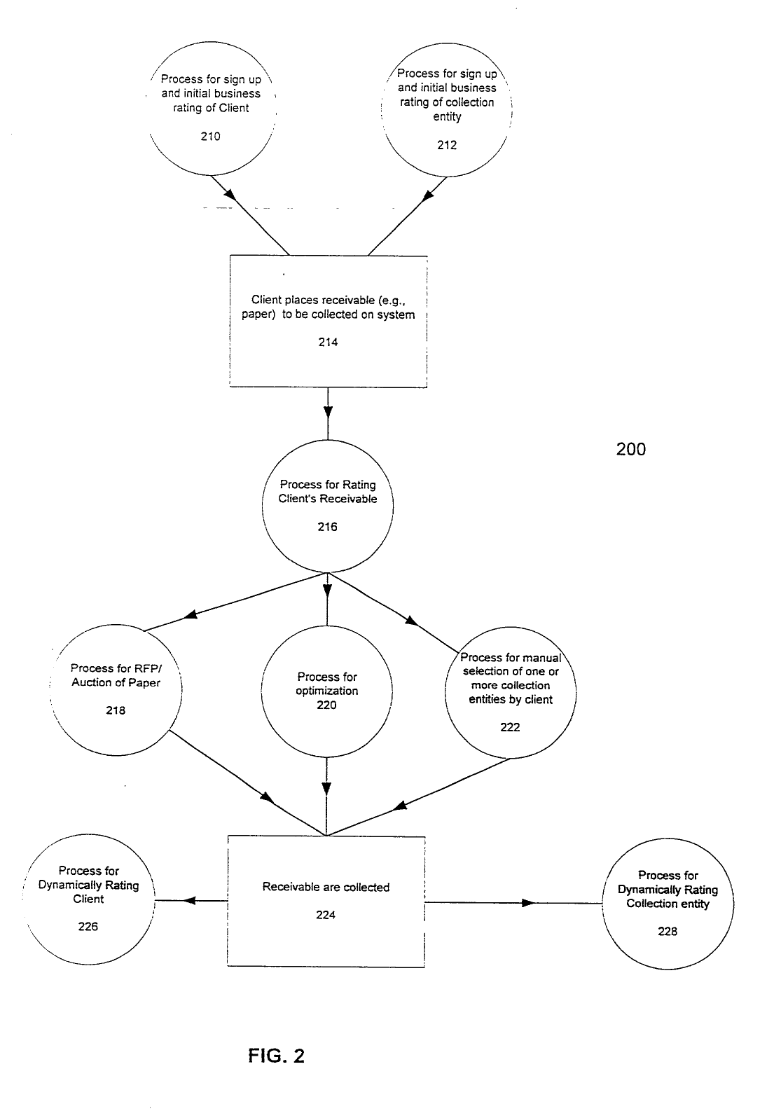

FIG. 2 is an example of a flowchart 200 of a method for providing collections services according to an embodiment of the present invention. Step 210 illustrates a process for sign up and initial business rating of Client. Step 212 illustrates a process for sign up and initial business rating of a collection entity. At step 214, a Client may place one or more receivable accounts (e.g., paper) to be collected on the system of the present invention. Step 216 illustrates a process for rating a Client's one or more receivable accounts (e.g., paper). Next, a Client may choose from three or more processes. For example, step 218 illustrates a process for Request for Proposal (“RFP”)/Auction of Paper. Step 220 illustrates a process for optimization. Step 222 illustrates a process for manual selection of one or more collection entities by a Client. Other alternatives may also be made available to a Client. At step 224, receivable accounts (e.g., paper) may be collected. Step 226 illustrates a process for dynamically rating a Client. Step 228 illustrates a process for dynamically rating a collection entity.

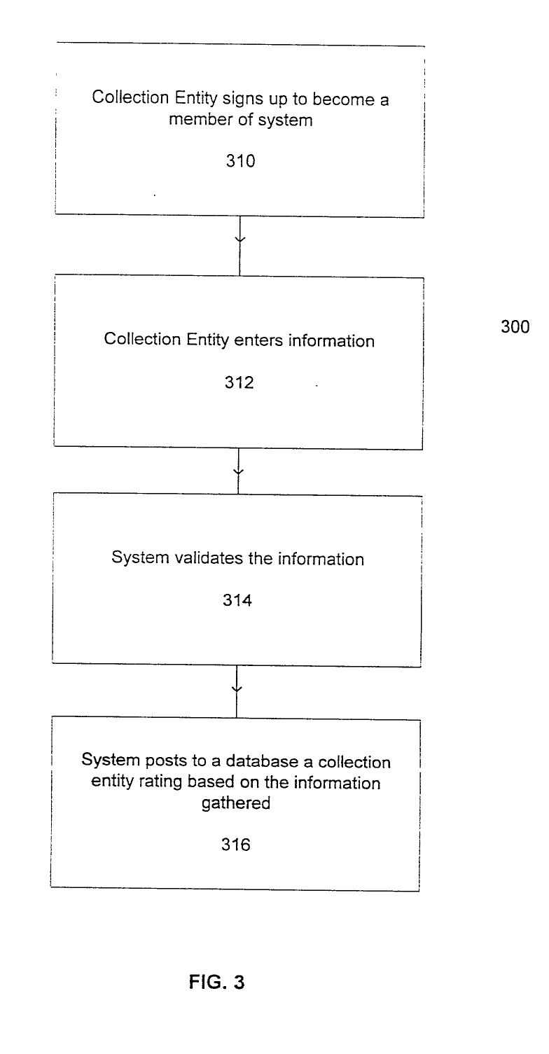

FIG. 3 illustrates the details of a process 300 for sign up and initial business rating of a collection entity according to an embodiment of the present invention. At step 310, a collection entity may sign up to become a member of a system of the present invention. At step 312, a collection entity may enter various forms of information. For example, such information may include organization characteristics, history, pending actions, and other information. At step 314, the system of the present invention may validate the information entered by the collection entity.

At step 316, the system may post a collection entity rating based on information entered by the collection entity and from other sources to a database.

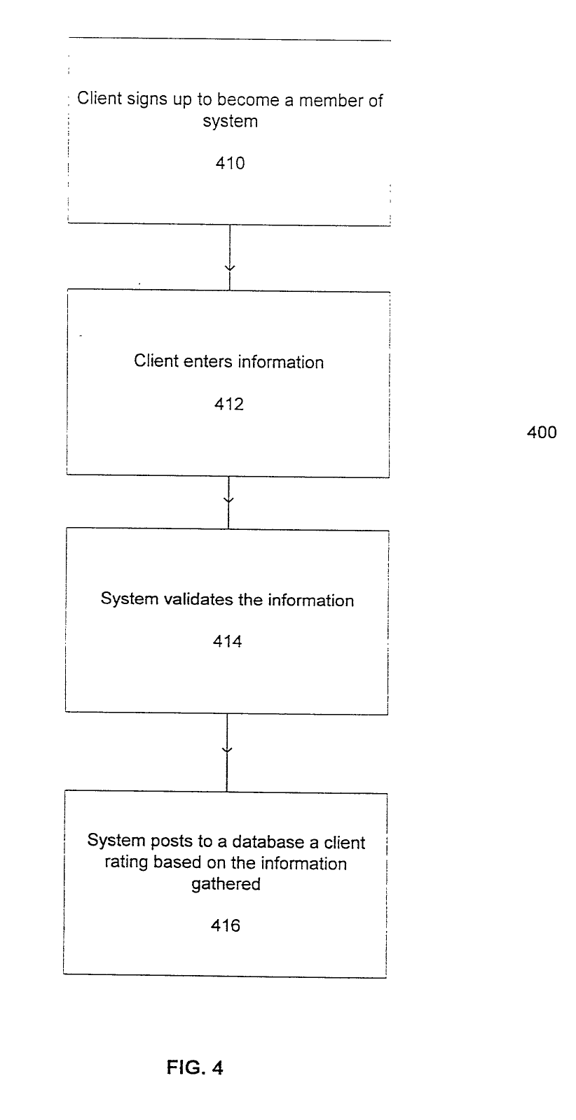

FIG. 4 illustrates details of a process 400 for sign up and initial business rating of a Client according to an embodiment of the present invention. At step 410, a Client may sign up to become a member of a system of the present invention. At step 412, the Client may enter various information, including information regarding characteristics of an associated organization, history, dollars placed per year and other information. At step 414, the system of the present invention may validate the information. At step 416, the system may then post a Client rating based on the information gathered and from other sources to a database.

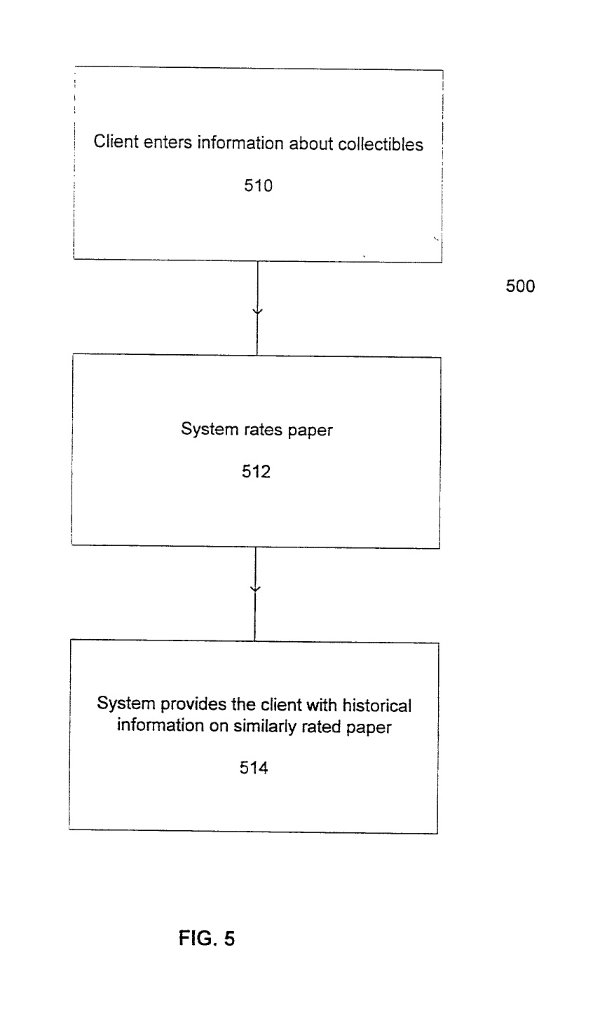

FIG. 5 illustrates details of a process 500 for rating a Client's paper or other receivable according to an embodiment of the present invention. At step 510, a Client may enter information about collectibles, such as delinquent accounts, for example. For example, the information entered may include type of paper, age of paper, whether a phone number and address exists, and other information. At step 512, the system may rate the paper based on various factors or information. At step 514, the system may provide the Client with historical information on similarly rated paper. For example, the Client may view historical information regarding their placements with the system along with other relevant information.

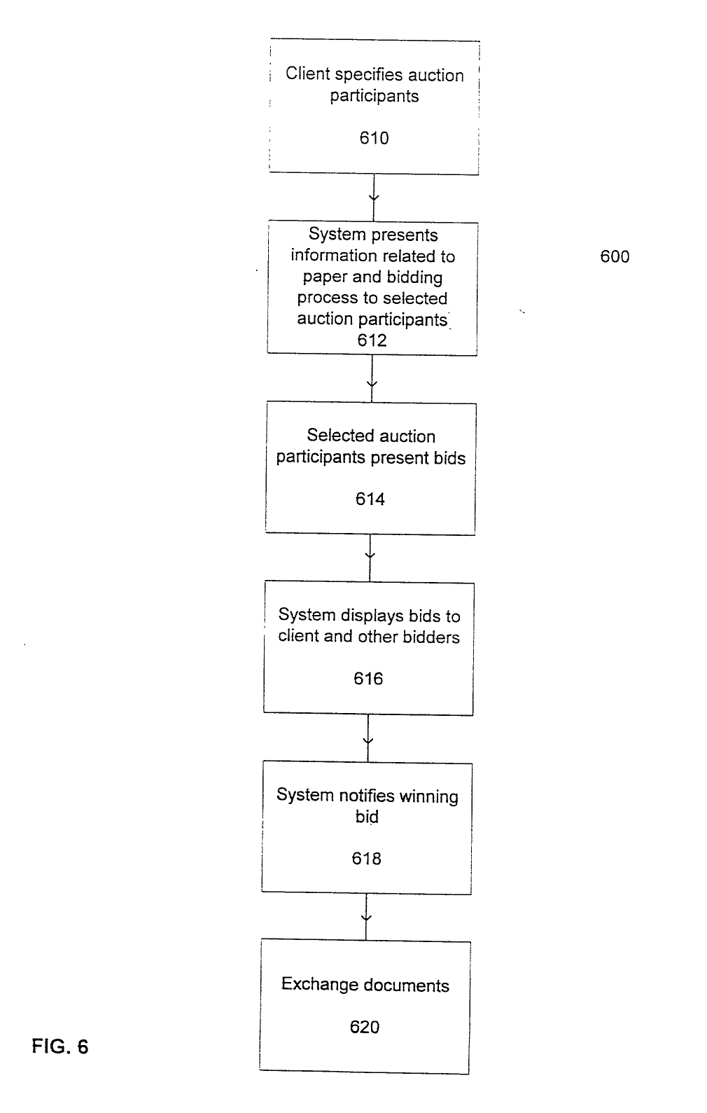

FIG. 6 illustrates details of a process 600 for RFP or an auction of paper according to an embodiment of the present invention. At step 610, a Client may specify auction participants. For example, a Client may select the type and range of collection entities that may be invited to bid on an account (or receivable) for collection. According to another embodiment, a Client may open the bid to all who would like to partake in the bidding process. Other limitations may also be enforced by the Client or other party. For example, a collection agency may request to be removed from consideration of bids from one or more specified Clients. At step 612, the system may present information related to a paper and bidding process to the selected auction participants. For example, the system may communicate to the selected collection entities the information concerning the paper up for bid and the details of the bidding process via email or other means of communication. At step 614, the selected auction participants may present bids. At step 616, the system may display bids to Client and other bidders. For example, the collection entities who want to bid may communicate their bid or bids using the Internet or other mode of communication. At step 618, the system may then notify the winning bid or bids. The current winning bid or bids may then be displayed to the Client and other bidders via the Internet or some other communication medium. The appropriate documents and other information may then be exchanged at step 620. For example, the auction may be terminated as determined by a predetermined time limit or other definable event.

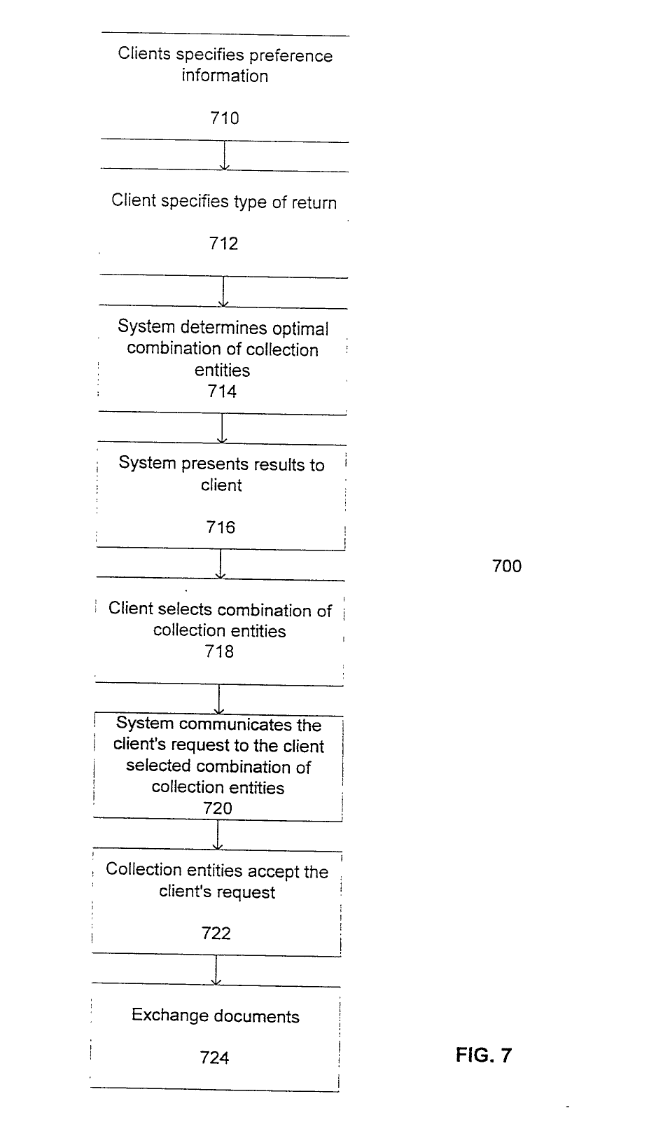

FIG. 7 illustrates details of a process 700 for optimization according to an embodiment of the present invention. At step 710, a Client may specify preference information. For example, preference information may include size of collector, maximum and/or minimum number of collection entities returned and other information. At step 712, the Client may also specify the type of return as well as other limitations and requests. For example, the type of return may include maximum return, maximum return in shortest time, maximum return by a specified date, maximum return based on historical data of one or more particular collection entities, and other criteria. At step 714, the system may determine an optimal combination of collection entities. For example, given the information on the paper (e.g., receivable), the system may use artificial intelligence techniques and/or neural networks and/or other processes to determine a combination of collection entities who may be capable of giving the Client an optimal return based on his criteria, preferences, and other factors. In addition, a single collection entity may be suggested by the system as well as a combination of collection entities. At step 716, the system may present results to the Client. At step 718, the Client may select a desired combination of collection entities. At step 720, the system may communicate the Client's one or more requests to the Client selected combination of collection entities. At step 722, the one or more collection entities may accept the Client's one or more requests. The appropriate documents and other information may then be exchanged at step 724. In another example, the selection process may be reinitialized if no selection is made.

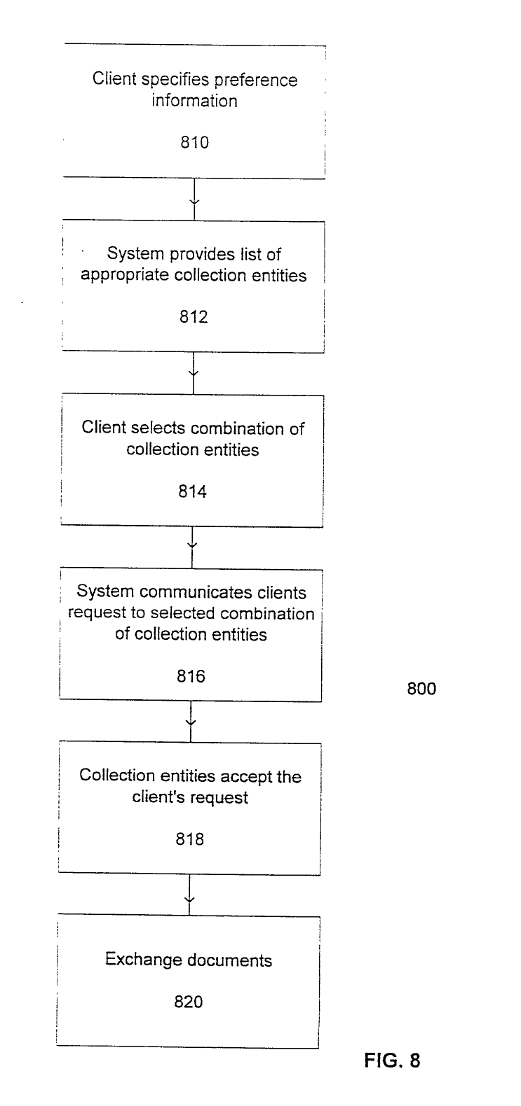

FIG. 8 illustrates details of a process 800 for manual selection of collection entities by a Client according to an embodiment of the present invention. At step 810, a Client may specify preference information, which may include size of collector, type of agency, maximum number of collection entities returned and other information. At step 812, the system may provide a list of appropriate collection entities based on information stored in the databases of the present invention, Client preference information, and other information. At step 814, the Client may select a desired combination of collection entities. The combination of collection entities may include one or more collection entities. The Client may also examine the ratings and other detailed information concerning the selected collection entities. At step 816, the system may communicate Client's request or requests to the selected one or more collection entities. Upon receiving the Client's request, the one or more collection entities may accept the Client's request, at step 818. The appropriate documents may then be exchanged, at step 820. In another example, the selection process may be reinitialized if no selection is made.

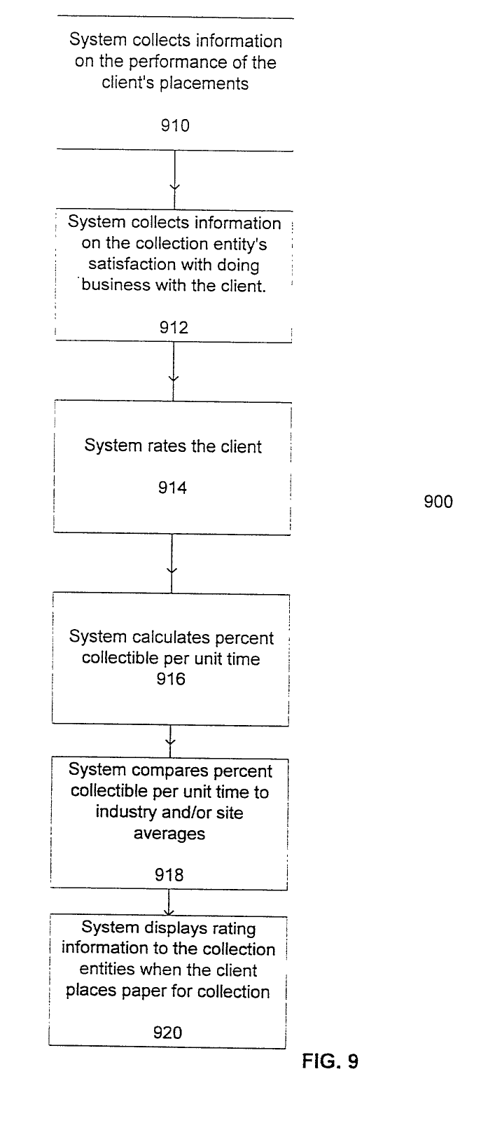

FIG. 9 illustrates a process 900 for dynamically rating a Client according to an embodiment of the present invention. At step 910, the system may collect information on the performance of the Client's placements. At step 912, the system may collect information on the collection entity's satisfaction with doing business with the Client. At step 914, the system may rate the Client where the rating may include average age of placement, dollars placed per year, nonpayment complaints, completeness and accuracy of information, percent of paper collected defined by age, total percent collectible, and other information. At step 916, the system may calculate percent collectible per unit time. At step 918, the system may compare the percent collectible per unit time to industry and/or site averages. At step 920, the system may display rating information to the collection entities when the Client places the paper for collection. For example, this may be used by the collection entities to determine if they want to pursue the Client's business.

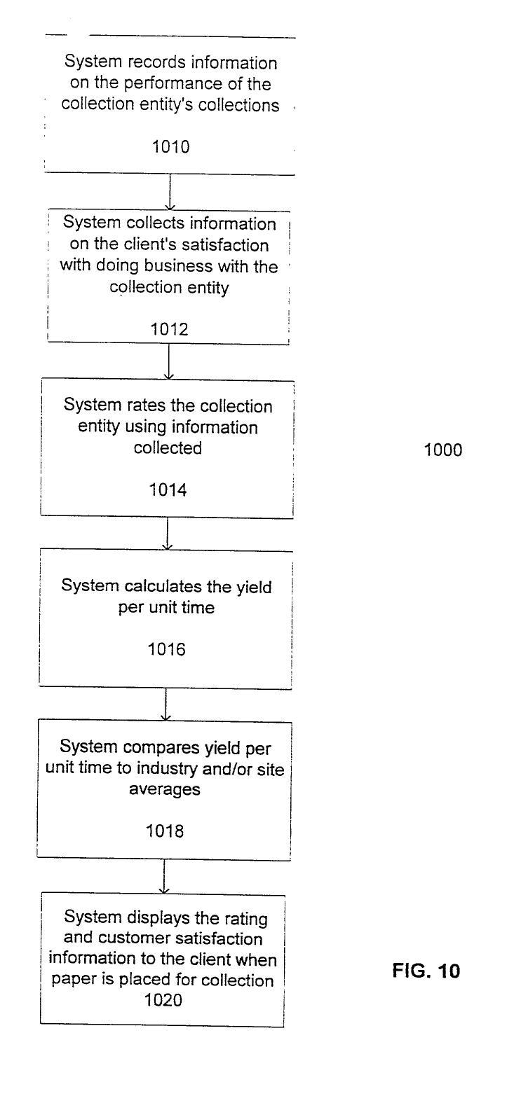

FIG. 10 illustrates a process 1000 for dynamically rating collection entities according to an embodiment of the present invention. At step 1010, the system may record information on the performance of the collection entities' collections. At step 1012, the system may collect information on the Client's satisfaction with doing business with the collection entity. At step 1014, the system may rate the collection entity using the information collected. For example, ratings may include volume placed, amount collected/amount placed, average rate, average yield to Client, yield to Client per time period both total and by paper type, and other information. At step 1016, the system may calculate the yield per unit time. At step 1018, the system may compare the yield per unit time to industry and/or site averages. At step 1020, the system may display the rating and customer satisfaction information to the Client. For example, the Client may view the rating information when the Client places the paper for collection. This rating information may be used by the Client to determine if they want to pursue business with the collection entity. According to another example, the rating information may also be used by the optimization process of FIG. 7 to determine the best fit for a Client's paper.

Other embodiments and uses of the invention will be apparent to those skilled in the art from consideration of the specification and practice of the invention disclosed herein. The specification and examples should be considered exemplary only.

What is claimed is:

1. A method for providing an online collections services marketplace to assist Clients in identifying one or more Providers for collecting associated receivables, comprising the steps of:
subscribing with an online collections services system wherein a Client inputs profile data;
providing information related to receivables for collection through the online collections services system;
storing in a database Client profile data and information related to receivables; and
selecting one or more Providers based on one or more placement options.

2. The method of claim 1 wherein the placement option comprises a step of participating in a bidding process where the Client submits a set of receivables for auction and specifies limitations regarding the bidding process.

3. The method of claim 1 wherein the placement option comprises a step of invoking an optimization process where a set of Providers able to provide an optimal return is displayed to the Client for selection.

4. The method of claim 1 wherein the placement option comprises a step of searching for one or more Providers based on Client defined characteristics wherein the Client initiates contact with the one or more Providers.

5. The method of claim 1 further comprising a step of utilizing Provider data in selecting one or more Providers wherein Provider data comprises one or more of Provider type, Provider qualification data, feedback data and efficiency rating data.

6. The method of claim 1 further comprising a step of dynamically rating the one or more selected Providers with respect to Provider performance in servicing receivables with one or more defined characteristics.

7. A method for providing an online collections services marketplace to enable Providers to offer collection services to one or more Clients, comprising the steps of:
subscribing with an online collections services system wherein a Provider inputs Provider data;
viewing one or more receivable ratings associated with one or more Clients;
providing one or more exclusion factors to be applied to a Client selection process; and
making a determination in response to a Client selection.

8. The method of claim 7 further comprising a step of participating in a bidding process where the Provider submits one or more bids for one or more sets of receivables for auction.

9. The method of claim 7 further comprising a step of viewing current bids of other participating bidders without revealing the identity of the other participating bidders.

10. The method of claim 7 further comprising a step of dynamically rating one or more Clients.

11. A system for providing an online collections services marketplace to assist Clients in identifying one or more Providers for collecting associated receivables, comprising:
a subscription module for subscribing with an online collections services system wherein a Client inputs profile data;
an input module for providing information related to receivables for collection through the online collections services system;
a database storing Client profile data and information related to receivables; and
a selection module for selecting one or more Providers based on one or more placement options.

12. The system of claim 11 wherein the placement option comprises a bidding module for participating in a bidding process where the Client submits a set of receivables for auction and specifies limitations regarding the bidding process.

13. The system of claim 1 1 wherein the placement option comprises an optimization module for invoking an optimization process where a set of Providers able to provide an optimal return is displayed to the Client for selection.

14. The system of claim 11 wherein the placement option comprises a search module for searching for one or more Providers based on Client defined characteristics wherein the Client initiates contact with the one or more Providers.

15. The system of claim 11 further comprising a utilization module for utilizing Provider data in selecting one or more Providers wherein Provider data comprises one or more of Provider type, Provider qualification data, feedback data and efficiency rating data.

16. The system of claim 11 further comprising a feedback module for dynamically rating the one or more selected Providers with respect to Provider performance in servicing receivables with one or more defined characteristics.

17. A system for providing an online collections services marketplace to enable Providers to offer collection services to one or more Clients, comprising:
a subscription module for subscribing with an online collections services system wherein a Provider inputs Provider data;
a ratings module for viewing one or more receivable ratings associated with one or more Clients;
an exclusion module for providing one or more exclusion factors to be applied to a Client selection process; and
a determination module for making a determination in response to a Client selection.

18. The system of claim 17 further comprising a bidding module for participating in a bidding process where the Provider submits one or more bids for one or more sets of receivables for auction.

19. The system of claim 17 further comprising a display for viewing current bids of other participating bidders without revealing the identity of the other participating bidders.

20. The system of claim 17 further comprising a feedback module for dynamically rating one or more Clients.
